(19) United States
(12) Patent Application Publication
(10) Pub. No.: US 2023/0243469 A1
(43) Pub. Date: Aug. 3, 2023

(54) SECURING OF GLOVED INTERVENTIONS

(71) Applicant: BAUSCH + STRÖBEL MASCHINENFABRIK ILSHOFEN GMBH+CO.KG, Ilshofen (DE)

(72) Inventors: Laura DURST, Vellberg (DE); Florian GRIMM, Kreßberg (DE); Thomas KORELLA, Wolpertshausen (DE)

(73) Assignee: BAUSCH + STROBEL SE + CO.KG, Ilshofen (DE)

(21) Appl. No.: 18/010,754

(22) PCT Filed: Jun. 10, 2021
(86) PCT No.: PCT/EP2021/065711

§ 371 Date: Dec. 15, 2022

(30) Foreign Application Priority Data
Jun. 15, 2020 (DE) 20 2020 103 410.3

(51) Int. Cl. F16P 3/14; B25J 21/02

(52) U.S. Cl. CPC F16P 3/144; B25J 21/02

(57) ABSTRACT

A safety device for gloved intervention. A glovebox comprises a wall comprising an opening. A light curtain is in the glovebox. Upon acquisition of an object intervening through the curtain, a machine's operation is stopped. The device comprises a shaft extending inside the glovebox along an axis of rotation, an actuation element actuatable to allow axial movement of the shaft, a housing through which the shaft is guided, and a cover fastened to the shaft to a rotational axis. The housing is fastened to a wall. In a closed state, the cover closes the opening and can switch into an open state with rotational movement. The shaft and the housing are coupled to secure against twisting in a prevention position. The shaft is rotatable, in a rotational position, for switching between closed and open cover states. The curtain can detect the shaft and/or the cover in the rotational position.

The invention relates to a safety device for gloved intervention in a glovebox of a machine, wherein the glovebox comprises a wall in which an opening is provided which allows for gloved intervention, wherein a light curtain is arranged in the glovebox, which is coupled to the machine such that, upon acquisition of an object intervening through the light curtain, the operation of the machine is stopped.

Gloved interventions are essential in many pharmaceutical manufacturing processes. They allow access to the manufacturing facilities, in order that malfunctions can be remedied in the case of an interruption to production, without having to open the safety device. Thus, aseptic production without risks of contamination can be ensured.

However, in order to prevent uncontrolled, spontaneous access via the gloves, the machine should preferably be equipped with a safety device for gloved intervention.

A mechanical safety slide is known from DE 91 04 920 U1, which closes glove apertures of a glovebox by means of a lateral movement, and releases the glove apertures again by means of a return movement.

A safety device of a glove socket is known from DE10 2018 209 249 A1, which comprises a glove ring and a sensor device which is arranged on the glove ring, wherein the sensor device is designed to detect intervention of an object, in particular a hand, into the glove ring.

CH 709 889 A2 describes an RFID-based identification system for identifying the presence of a person at a glovebox, which system comprises an RFID transponder which is intended to be worn by a particular person. A reader unit is arranged on the glovebox, which reader unit is intended to signal the presence of the operator equipped with the transponder upon entry of said operator.

A safety device for gloved intervention is furthermore known from EP 2627 484 B1, wherein the safety device comprises a locking unit having a distance sensor which is engaged in a stop portion of a flap in a closed state, and thus blocks the access to the glovebox, wherein an alarm signal is generated as soon as the flap is raised upwards to a transition state for opening, and the distance sensor has detected the position, thus raised, of the stop portion.

Various solutions are also offered on the market from different manufacturers, a plurality of these using a light curtain which is arranged inside a glovebox. As soon as the light curtain is interrupted by intervention into the glovebox, the machine receives a signal and is automatically forced to stop. However, all machines have a certain follow-up time, which varies depending on the machine type and features. On account of the inertia, the mechanical movement cannot be brought from full power immediately to standstill, wherein an abrupt change to standstill could furthermore lead to damage to the mechanical components. Since mechanical movements in the work region of the glove could still continue during the follow-up time, the possibility of touching still moving machine parts in the event of “quick” intervention cannot be excluded. This danger is contrary to the current safety guidelines such as DIN EN ISO 13855 and DIN EN ISO 13857.

An object of the present invention is that of providing, according to the following aspects, an improved or alternative solution for a safety device, compared with the prior art, in order to prevent the risk of injury, and thus to increase the safety of the gloved interventions, and simultaneously also to ensure maximum product protection.

According to a first aspect of the invention, the object is achieved by a safety device for gloved intervention in a glovebox of a machine, wherein the glovebox comprises a wall in which an opening is provided which allows for gloved intervention, wherein a light curtain is arranged in the glovebox, which is coupled to the machine such that, upon acquisition of an object intervening through the light curtain, the operation of the machine is stopped, wherein the safety device comprises: a shaft which is designed to extend from the outside to the inside of the glovebox, along an axis of rotation; an actuation element which is designed to be actuated by a user in order to allow an axial movement of the shaft; and a housing through which the shaft is guided, wherein the housing is designed to be fastened to the wall in a torque-proof manner; and a cover, which is designed to be fastened to the shaft, transversely to the axis of rotation of the shaft, wherein the cover is furthermore designed t close the opening, in a closed state, and to switch into an open state, and release the opening, by a rotational movement about the axis of rotation of the shaft, wherein the shaft and the housing are coupled together, such that the shaft, together with the cover, is secured against twisting in an axial rotation prevention position, and is rotatable, in an axial rotational position, for switching between the closed state and the open state of the cover, wherein the shaft and/or the cover is designed to be detected by the light curtain in the rotational position. Since the shaft is rotatable only if it and/or the cover is detected by the light curtain in the axial rotational position, it is possible to ensure that the machine is already stopped before the user can intervene, with a glove, in the producing machine. Thus, risks of injury are prevented, with the result that the safety of the gloved intervention can be ensured. Furthermore, depending on the embodiment, the cover could be pivoted in all directions, whereas in many solutions in the prior art opening of the cover is possible only to the right or to the left. Furthermore, the safety device according to the invention can be easily mounted in the wall of the glovebox as a separate unit, and can allow for the securing of gloved interventions with the aid of a combination of a mechanical intervention protection and the light curtain, already present in the glovebox, which generates the signal for stopping the machine, such that the costs and the construction outlay can be significantly reduced. Furthermore, on account of the separate construction, the safety device can be dismantled and cleaned easily, such that hygiene requirements can also be met.

In a preferred embodiment, the safety device further comprises a curved path part having a guide stretch which is attached to the shaft in a torque-proof and axially non-displaceable manner, or is integrally integrated with the shaft, and a guide element which is firmly attached to the housing on the inside or integrally integrated with the housing, wherein the guide element is designed to engage in the guide stretch of the curved path part, wherein the rotational position of the shaft is determined by the position of the guide element. The guide stretch is preferably designed as an indentation on a surface of the curved path part, while the guide element is preferably designed as a projection on a surface of the housing. As soon as the guide element has been introduced into the guide stretch, a defined rotational movement of the shaft can be made possible by means of positive driving of the guide element on the guide stretch, wherein the maximum angle of rotation of the shaft is determined by the length of the guide stretch.

In order to introduce the guide element into the guide stretch or to allow for a transition between the rotation prevention position and the rotational position, the curved path part comprises an admission opening which passes through from the guide stretch to a side of the curved path part which faces the guide element in the rotation prevention position, and which is designed to admit the guide element into the guide stretch by means of an axial movement of the shaft.

Before the shaft has reached the axial rotational position, it is to be secured against twisting. The safety device thus preferably further comprises a covering part, which is firmly attached to the housing, on the inside, or integrally integrated with the housing, wherein the covering part comprises a surface which is designed to interact with a surface of the curved path part, such that the shaft is secured against twisting in the rotation prevention position. An integral construction of the covering part allows for the omission of screws which serve to fasten the covering, wherein the cleaning of the safety device can be significantly improved thereby. The guide stretch preferably comprises a start position and an end position. In order to secure the cover, after twisting and in the open state, against twisting back, the curved path part preferably further comprises a recess at the end position of the guide stretch, which is connected to the guide stretch, wherein the guide element is designed to engage in the recess, by means of an axial movement, in order to secure the shaft against twisting, in a stop position.

The guide element is preferably designed as a bolt, wherein the bolt can have any desired cross section. The bolt can be firmly attached to the housing, or integrally integrated with the housing. In order to allow for the engagement between the guide element and the guide stretch, the bolt can furthermore comprise a rolling portion or a sliding portion, in order to allow or facilitate the rolling or sliding along the guide stretch.

The housing can also be formed integrally or in multiple parts, wherein an integral design can save on fastening means for connecting individual components, and thus simplify the cleaning of the safety device.

In order to prevent inadvertent axial movement of the shaft and a machine stop triggered thereby, the safety device preferably comprises a locking unit, wherein the locking unit is designed to prevent an axial movement of the shaft in a locking state, and to release this in a release state, such that the shaft is secured against unintended actuation.

The locking unit preferably comprises a lock which is preloaded into the locking state by means of a resilient element, wherein the resilient element is preferably designed as a compression spring. The lock is preferably designed to be pressed against the shaft, in the locking state, by means of the compression spring, in order to secure the shaft against an axial movement. In order to release the axial movement of the shaft, the lock is preferably to be pulled by a user in the direction opposite to the compression force of the compression spring.

The lock furthermore preferably comprises an oblique surface which is designed so as to allow a transition from the rotational position to the rotation prevention position of the shaft, merely by means of an axial movement of the shaft, wherein actuation of the locking unit is not necessary.

In addition to the axial movement, the actuation element is further designed to be actuated by a user in order to allow for a rotational movement of the shaft about the axis of rotation thereof. The actuation element can also be both coupled to the shaft or integrally integrated in the shaft, wherein the actuation element is preferably a clamping lever, a star knob, or an operating tool, which can be applied to a receiving geometry, in order to actuate the safety device. This would have the advantage that on the one hand the safety device would be more compact and would require less space, and on the other hand only selected operators could actuate the safety device.

According to a second aspect of the invention, the object is achieved by a facility, comprising: a glovebox of a machine, wherein the glovebox comprises a wall in which an opening is provided which allows for gloved intervention; a light curtain which is coupled to the machine such that, upon acquisition of an object intervening through the light curtain, the operation of the machine is stopped; and a safety device according to any of claims 1-14.

In order to prevent risks of injury in the shoulder and face region, and a restricted field of vision, in a preferred embodiment the housing is firmly attached to the wall, to the bottom left or bottom right of the opening. Furthermore, a pivot region of the cover can be minimized. Moreover, such positioning of the housing allows the shaft to be secured in the stop position, by means of the gravitational force of the cover, wherein the guide element cannot slip out of the recess, e.g. on account of vibrations, such that the cover is secured against falling out, in the stop position.

Alternatively or in addition, the housing is firmly attached to the wall on the outside, wherein a risk of contamination is minimized thereby.

In order to allow for gloved intervention, a glove is fastened to the opening. In the prior art, the glove usually hangs outwards without protection, and is clamped by a flap, wherein there is a risk, in the case of such a design, that the entire production batch may be rejected on account of possible contamination, due to damage to the glove. In order to prevent this, the cover is preferably fastened to the shaft, inside the glovebox, more preferably at one end of the shaft, inside the glovebox.

The invention will be explained in greater detail in the following, with reference to an embodiment. In the accompanying drawings:

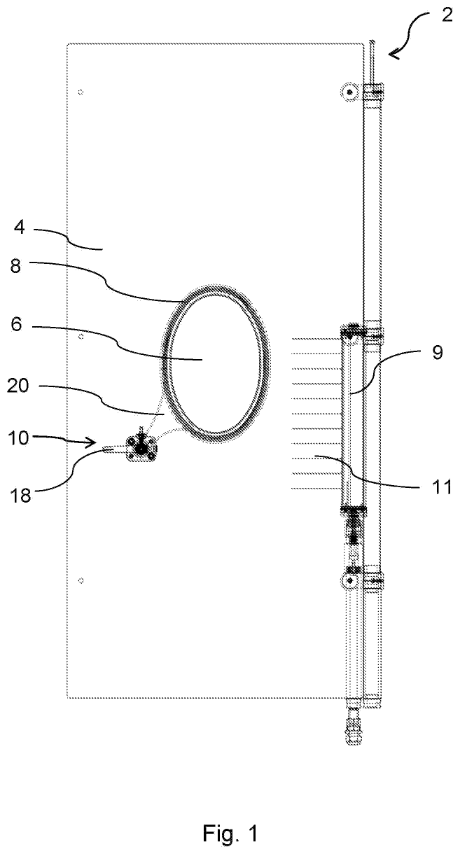

FIG. 1 is a front view of a glovebox comprising a safety device;

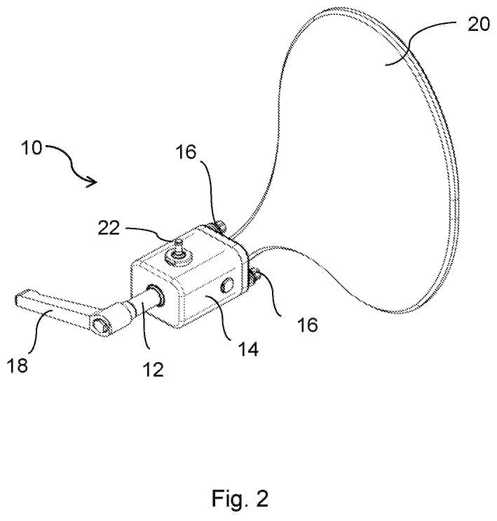

FIG. 2 is a perspective view of the safety device from FIG. 1;

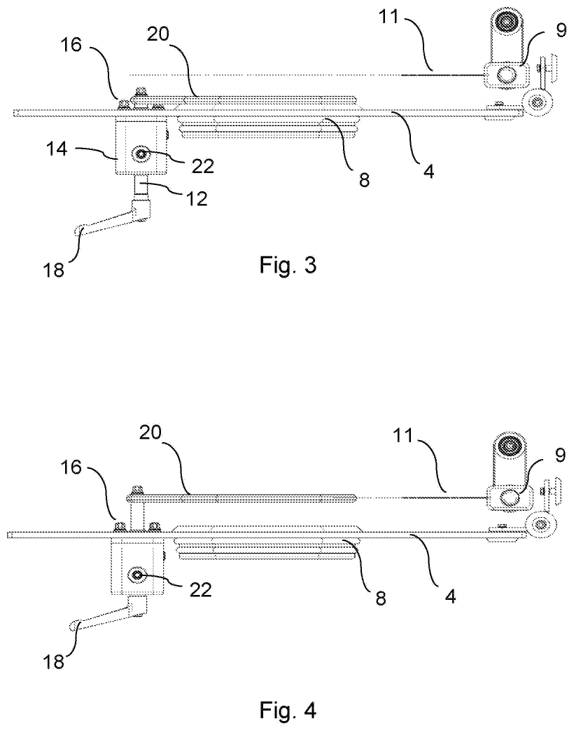

FIG. 3 is a plan view of the glovebox comprising the safety device from

FIG. 1, wherein the shaft of the safety device is in an axial rotation prevention position;

FIG. 4 is a plan view of the glovebox comprising the safety device from

FIG. 1, wherein the shaft of the safety device is in an axial rotational position;

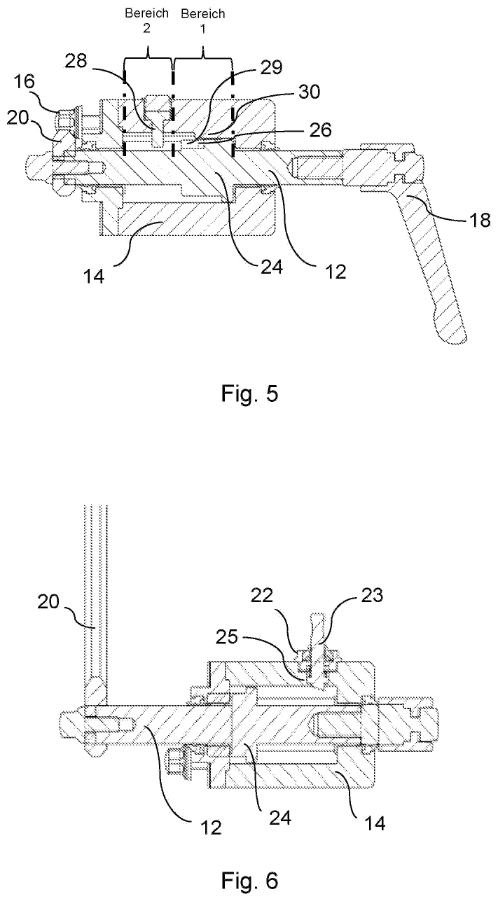

FIG. 5 is a sectional plan view of the safety device from FIG. 1;

FIG. 6 is a sectional side view of the safety device from FIG. 1.

FIG. 1 is a front view of a glovebox 2 of a machine comprising a safety device 10 according to an embodiment of the invention. The glovebox 2 comprises a wall 4 in which an opening 6 is provided which allows for gloved intervention. A ring 8 surrounding the opening is provided on the wall 4, wherein a glove is fastened to the opening, which glove is not shown in FIG. 1. A light curtain 9 is arranged inside the glovebox, which light curtain is coupled to the machine such that the operation of the machine is stopped upon interruption of a light beam of the light curtain 9 by an intervening object.

As can be seen from FIG. 1 and FIG. 2, the security device 10 comprises a shaft 12 which extends along an axis of rotation, and a housing 14 through which the shaft 12 is guided, wherein the housing 14 is fastened to the wall 4 in a torque-proof manner, by means of fastening screws 16, to the bottom left of the opening 6. A clamping lever 18 is coupled to one end of the shaft, which clamping lever is preferably designed to be actuated by a user, in order to allow both an axial movement of the shaft along the axis of rotation, and a rotational movement of the shaft about the axis of rotation. The safety device 10 further comprises a cover 20 which is designed to be fastened to the shaft transversely to the axis of rotation, wherein the cover 20 is furthermore designed to close the opening 6, in a closed state, and to switch into an open state by means of a rotational movement about the axis of rotation, and release the opening 6. In order to secure the shaft 12 against inadvertent actuation, and to prevent a machine stop triggered thereby, a locking unit 22 is preferably provided on the housing 14, which locking unit is designed to prevent an axial movement of the shaft in a locking state, and to release this in a release state.

FIG. 3 is a plan view of the glovebox 2 comprising the safety device 10 from FIG. 1, wherein the shaft 12 of the safety device 10 is in an axial rotation prevention position, while FIG. 4 is also a plan view of the glovebox 2, wherein the shaft 12 of the safety device 10 is in an axial rotational position. It can be seen that the shaft 12 extends from the outside to the inside of the glovebox 2, along the axis of rotation thereof, wherein the cover 20 is firmly attached to one end of the shaft 12, inside the glovebox 2.

The shaft 12 and the housing 14 are coupled together such that the shaft 12, together with the cover 20, is secured against twisting in the axial rotation prevention position shown in FIG. 3, wherein it can be seen that the shaft 12 and the cover 20 are not detected by the light curtain 9, in the rotation prevention position. In comparison therewith, in the axial rotational position shown in FIG. 4, the shaft 12 and the housing 14 are coupled together such that the shaft 12 is rotatable, wherein it can be seen that the shaft 12 and/or the cover 20 interrupt a light beam 11 of the light curtain 9, in the rotational position, and thus the operation of the machine is stopped. The safety device 10 is designed such that the shaft 12 is rotatable only if it and/or the cover 20 is detected by the light curtain 9 in the axial rotational position. It is thus possible to ensure that the machine is already stopped before a glove can intervene in the producing machine, such that the risk of injury can be avoided.

FIG. 5 and FIG. 6 show, by way of example, the way in which the housing 14 and the shaft 12 can be coupled together, in the embodiment according to the above explanations. As can be seen from FIG. 5, a curved path part 24 is attached to the shaft 12 in a torque-proof and axially non-displaceable manner, wherein the curved path part 24 comprises a guide stretch 26 of a particular length, which is formed as an indentation on a surface of the curved path part 24. A guide element 28 is firmly attached to the housing 14 on the inside, which guide element, in the embodiment, is designed as a bolt 28. The bolt 28 is designed for engaging in the guide stretch 26 of the curved path part 24, wherein the rotational position of the shaft 12 is determined by the position of the guide element 24.

In order to introduce the bolt 28 into the guide stretch 26, the curved path part 24 comprises an admission opening 29 which is designed to admit the guide element 28 into the guide stretch 26 by means of an axial movement of the shaft 12.

Before the shaft 12 has reached the rotational position, in which the light curtain 9 is interrupted, the shaft 12 has to be secured against twisting. The safety device 10 thus preferably further comprises a covering part 30, which is integrated on the inside and integrally with the housing 14, wherein the covering part 30 comprises a milled surface which is designed to interact with a milled surface of the curved path part 24, such that twisting of the shaft is prevented in the rotation prevention position.

The guide stretch 26 of the curved path part 24 comprises a start position and an end position, wherein a recess is provided at the end position of the guide stretch, which recess is not shown here in the drawings. The recess is connected to the guide stretch, wherein the bolt 28 is designed to engage in the recess, by means of an axial movement, in order to secure the shaft 12 against twisting, in a stop position.

The guide stretch is of a length which is defined by the start position and the end position, wherein the length determines the pivoting range of the cover 20. Depending on the position in which the housing of the safety device is arranged with respect to the opening of the glovebox, the necessary pivoting range of the cover 20 is different, in order to release the opening 6. In the embodiment shown here, the housing 14 is arranged to the bottom left of the opening 6, as a result of which the pivoting range of the cover can be minimized, and can be merely approximately 65°. Furthermore, in variants of the embodiment shown here, a different pivoting range can also be selected, depending on the boundary conditions.

As a result of the minimized pivoting range, the cover 20 that is pivoted out is not in the field of vision of the user. Furthermore, the bolt 28 is secured in the stop position by means of the gravitational force of the cover, such that it cannot slip out of the recess due to vibrations, and cause the cover to fall down.

As can be seen from FIG. 6, the locking unit 22 comprises a lock 23 which is secured in the housing 14, against twisting, by means of a surface, and is pressed against the shaft 12, in a locking state, by means of a compression spring 25. Thus, undesired displacement of the shaft 12, and a resulting interruption of the light curtain 9, is not possible. Only when the lock 23 is pulled upwards can the shaft 12 be pushed in the direction of the light curtain 9. As a result, the lock 23 can be released again. On account of an oblique surface of the lock 23, the lock 23 latches back into the locking state, in the event of the shaft 12 returning into its home position. The shaft 12 is thus secured against undesired actuation.

The mode of operation of the of the safety device 10 according to the embodiment shown can furthermore be summarized, by way of example, in the following steps, with reference to FIG. 5 and FIG. 6:

Step 1: Release locking By means of pulling out the lock 23 the shaft 12 is unlocked, and can thus be displaced axially.

Step 2: Displacement (region 1)

The shaft can be pushed axially in the direction of the glovebox 2. Twisting of the cover 20 is prevented in this region by means of interaction of a milled surface of the curved path part 24 on the shaft 12, and a milled surface of the covering part 30 on the housing 14.

Step 3: Displacement (region 2) In this region, the shaft can also be pushed axially in the direction of the glovebox 2. In this case, firstly twisting prevention is achieved by means of the curved path part 24. Only when the axial rotational position is reached, in which the bolt 28 is in engagement with the guide stretch 26, is twisting of the shaft 12 possible, wherein the light curtain 9 is interrupted, in the rotational position, by the shaft 12 and/or the cover 20, and the machine stops.

Step 4: Twisting (opening)

In the rotational position, the shaft 12 can be rotated together with the cover 20, in order to release the opening 6. The length of the curved path part 24 makes it possible for the pivoting angle of the cover 20 to be limited to a value of 65°. If the end position of the guide stretch 26 is reached, the shaft 12 can be pushed in again by for example 5 mm (axial end stop), and is thus again secured against twisting.

1. A safety device for gloved intervention in a glovebox of a machine, the glovebox comprising a wall, the wall comprising an opening that allows for gloved intervention, wherein a light curtain is arranged in the glovebox coupled to the machine such that, upon acquisition of an object intervening through the light curtain, an operation of the machine is stopped, wherein the safety device comprises:
a shaft configured to extend from an outside of the glovebox to an inside of the glovebox along an axis of rotation of the shaft;
an actuation element that is actuatable to allow an axial movement of the shaft; and
a housing through which the shaft is guided, wherein the housing is configured to be fastened to the wall in a torque-proof manner; and
a cover configured to be fastened to the shaft transversely to an axis of rotation of the shaft, wherein the cover is configured, in a closed state, to close the opening and wherein the cover is configured to switch into an open state with rotational movement about the axis of rotation of the shaft and to release the opening,
wherein the shaft and the housing are coupled together such that the shaft, together with the cover is secured against twisting in an axial rotation prevention position, and wherein the shaft is rotatable, in an axial rotational position, for switching between the closed state and the open state of the cover, and wherein one or more of the shaft or the cover is detectable by the light curtain in the rotational position.

2. The safety device of claim 1, comprising:
a curved path part comprising a guide stretch, wherein the guide stretch is (A) attached to the shaft in a torque-proof and axially non-displaceable manner or (B) integrally integrated with the shaft; and
a guide element that is (a) firmly attached to the housing on an inside of the housing or (b) integrally integrated with the housing,
wherein the guide element configured to engage in the guide stretch of the curved path part, wherein the rotational position of the shaft is determined by the position of the guide element.

3. The safety device of claim 2, wherein the curved path part comprises an admission opening, wherein the admission opening passes through from the guide stretch to a side of the curved path part facing the guide element in a rotation prevention position, wherein the admission opening is configured to admit the guide element into the guide stretch with an axial movement of the shaft.

4. The safety device of claim 2, further comprising covering part wherein the covering part (i) is firmly attached to the housing on an inside of the housing, or (ii) is integrally integrated with the housing,
wherein the covering part comprises a surface configured to interact with a surface of the curved path part such that the shaft is secured against twisting in the rotation prevention position.

5. The safety device of claim 3, wherein the guide stretch comprises a start position and an end position, wherein the curved path part further comprises a recess at an end position of the guide stretch, wherein the recess is connected to the guide stretch, and wherein the guide element is designed is configured to engage in the recess, with an axial movement, to secure the shaft against twisting.

6. The safety device of claim 2, wherein the guide element comprises is a bolt.

7. The safety device of claim 1, wherein the housing is formed integrally or is formed in multiple parts.

8. The safety device of claim 1, further comprising a locking unit configured to prevent, in a locking state, an axial movement of the shaft and to release, in a release state, the shaft, such that the shaft is secured against unintended actuation.

9. The safety device of claim 8, wherein the locking unit comprises a lock preloaded into the locking state using a resilient element.

10. The safety device of claim 9, wherein the resilient element comprises is a compression spring.

11. The safety device of claim 9, wherein the lock comprises an oblique surface configured to allow a transition from the rotational position of the shaft to the rotation prevention position of the shaft with an axial movement of the shaft.

12. The safety device of claim 1, wherein the actuation element is further configured to be actuated by a user to allow for a rotational movement of the shaft about the axis of rotation of the shaft.

13. The safety device of claim 1, wherein the actuation element comprises a clamping lever, a star knob, or an operating tool.

14. A facility, comprising:
a glovebox of a machine, the glovebox comprising a wall, the wall defining an opening allowing for gloved intervention;
a light curtain coupled to the machine such that, upon acquisition of an object intervening through the light curtain, an operation of the machine is stopped; and
a safety device, comprising:
a shaft (configured to extend from an outside of the glovebox to an inside of the glovebox along an axis of rotation of the shaft
an actuation element that is actuatable to allow an axial movement of the shaft; and
a housing through which the shaft is guided, wherein the housing is configured to be fastened to the wall in a torque-proof manner; and
a cover configured to be fastened to the shaft transversely to an axis of rotation of the shaft, wherein the cover is configured, in a closed state, to close the opening and
wherein the cover is configured to switch into an open state with a rotational movement about the axis of rotation of the shaft and to release the opening,
wherein the shaft and the housing are coupled together such that the shaft, together with the cover, is secured against twisting in an axial rotation prevention position, and wherein the shaft is rotatable, in an axial rotational position, for switching between the closed state and the open state of the cover, and wherein one or more of the shaft or the cover is detectable by the light curtain in the rotational position.

15. The facility of claim 14, wherein the housing is firmly attached to the wall to a bottom left side of or to a bottom right side of the opening.

16. The facility of claim 14, wherein the housing is firmly attached to the wall on the outside of the wall.

17. The facility of claim 14, wherein the cover is fastened to the shaft inside the glovebox.

18. The facility of claim 14, the safety device further comprising:
a curved path part comprising a guide stretch, wherein the guide stretch is (A) attached to the shaft in a torque-proof and axially non-displaceable manner or (B) integrally integrated with the shaft; and
a guide element (that is (a) firmly attached to the housing on an inside of the housing or (b) integrally integrated with the housing,
wherein the guide element configured to engage in the guide stretch of the curved path part, wherein the rotational position of the shaft is determined by the position of the guide element.

19. The facility of claim 18, wherein the curved path part comprises an admission opening, wherein the admission opening passes through from the guide stretch to a side of the curved path part facing the guide element in a rotation prevention position, wherein the admission opening is configured to admit the guide element into the guide stretch with an axial movement of the shaft.

20. The facility of claim 18, the safety device further comprising a covering part, wherein the covering part (i) is firmly attached to the housing on an inside of the housing, or (ii) is integrally integrated with the housing,
wherein the covering part comprises a surface configured to interact with a surface of the curved path part such that the shaft is secured against twisting in the rotation prevention position.
